(19) United States
(12) Patent Application Publication
(10) Pub. No.: US 2025/0051656 A1
(43) Pub. Date: Feb. 13, 2025

(54) SYSTEMS AND METHODS TO UPGRADE A HYDROCARBON STREAM TO A LOWER BOILING POINT FEED MATERIAL

(71) Applicant: SABIC Global Technologies B.V., Bergen OP Zoom (NL)

(72) Inventors: Pankaj Gautam, Sugar Land, TX (US); Ravichander Narayanaswamy, Bangalore (IN); Alexander Stanislaus, Bangalore (IN); Hatem Belfadhel, Riyadh (SA)

(21) Appl. No.: 18/720,080

(22) PCT Filed: Dec. 15, 2022
(86) PCT No.: PCT/US2022/081613

§ 371 Date: Jun. 14, 2024

Related U.S. Application Data
(60) Provisional application No. 63/265,430, filed on Dec. 15, 2021.

(51) Int. Cl. C10G 47/04; B01J 8/00; B01J 8/18; B01J 8/22; B01J 8/26

(52) U.S. Cl. CPC C10G 47/04; B01J 8/007; B01J 8/1836; B01J 8/22; B01J 8/26; B01J 2208/00176; B01J 2208/00761; C10G 2300/1037; C10G 2400/20; C10G 2400/30

(57) ABSTRACT

Systems and methods for upgrading a hydrocarbon stream to a lower boiling point hydrocarbon feed material are disclosed. The system includes a feeding device to transport a hydrocarbon stream that includes an alternative feedstock. The hydrocarbon stream is partially cracked in a first cracking unit producing a lower boiling point hydrocarbon feed material, a catalyst rich heavy hydrocarbon stream, and coke. A slurry settler receives the catalyst rich heavy hydrocarbon stream and coke and separates the catalyst from the catalyst rich heavy hydrocarbon stream thereby defining a catalyst rich stream and a heavy hydrocarbon stream. A coking vessel receives the heavy hydrocarbon stream and coke and separates the heavy hydrocarbons from the coke thereby defining a heavy hydrocarbon stream. Finally, a second cracking unit that receives the lower boiling point feed material from the first cracking unit and produces olefins and aromatics.

### CROSS-REFERENCE TO RELATED APPLICATIONS

This application claims the benefit of and priority to U.S. Provisional Application No. 63/265,430, filed on Dec. 15, 2021, which is incorporated herein by reference in its entirety.

### TECHNICAL FIELD

Embodiments of the disclosure generally relate to systems and methods for upgrading a hydrocarbon stream. More specifically, the present disclosure relates to systems and methods for upgrading a hydrocarbon stream to a lower boiling point feed material.

### BACKGROUND

Crude oil may contain resins and asphaltenes that are difficult to convert and tend to coke during conversions leading to plugging of fixed bed hydroprocessing reactors. The difficulty of such a conversion and the produced coke results in a loss of valuable production time and provisioning of standby fixed bed units to address potential downtime issues. One solution, to alleviate such issues, is to subject the crude oil to solvent deasphalting to thereby produce deasphalted oil. The deasphalted oil may then be fed to a downstream hydroprocessing unit. However, a solvent deasphalted unit is not typically utilized at all existing facilities and may be installed as a new unit thereby adding or increasing substantially to the capital expenditure of an existing facility.

Further, the conversion of crude oil is an existing commercial process and employs one or more hydrocracker, e.g., high pressure reactors, operated at high pressure. However, the use of such high pressure reactors is costly or capital intensive. Further still, the conversion rate in the high pressure reactors is a maximum of 95 to 97% and such a conversion produces a product which includes a significant quantity of material with a boiling point above 350° Celsius. Such a material, with a boiling point above 350° Celsius, is, prior to transfer to a steam cracker, further converted to reduce the boiling point, thus incurring additional costs. Currently, crude oil is fed to an atmospheric tower and atmospheric residue produced in the atmospheric tower is fed to the vacuum tower. Streams from the vacuum tower are fed to a hydrocracking unit or hydrocracker for upgrading the streams into feeds for use as a downstream product in a single or multiple hydrocracking units.

Additionally, waste plastics may be converted to high-value chemicals (e.g., olefins, aromatic hydrocarbons, etc.) via pyrolysis. However, plastics pyrolysis may yield product streams having a wide boiling range. Conventionally (under common pyrolysis process conditions), some pyrolysis product streams, including pyrolysis oil (pyoil) streams, are in a liquid phase, while others are in a gas phase. The liquid phase pyrolysis product streams are generally further cracked or treated to increase the yield of high-value chemicals, while the gas phase high-value chemicals are flowed to separating units for recovery of high-value chemicals or as a feedstock for making high value chemicals.

Pyoil from conventional low severity pyrolysis of plastics generally contains about 20 to 40 wt. % olefins and about 10 wt. % aromatics. Therefore, the pyoil has to be saturated prior to being fed into a steam cracker whereas it is not necessary to saturate the pyoil for feeding to the fluid catalytic cracker unit (FCC unit) to produce high value chemicals. In fact, it is more advantageous to feed the olefin containing material to a FCC unit from a cracking perspective. The steam cracker feed streams generally have less than 1 wt. % olefins. Higher yields of high value chemicals (HVC), such as C₂ to C₄ olefins, benzene, toluene, xylenes (BTX) and ethyl benzene (EB), are produced from a lower aromatic (steam or catalytic) cracker feed, thus aromatics in a feed are attempted to be kept at as low a level as possible. Therefore, a large amount of hydrogen is generally used in hydrogenating thereby resulting in high production cost for producing high value chemicals. So, preserving the hydrogen content of plastic in the feed in the pyrolysis product produced is desired based on a downstream potential to form high value chemicals with low hydrogen consumption.

Furthermore, in commercially practiced processes the overall carbon efficiency for cracking plastics is relatively low, with a yield of about 70% liquid products as a feed for downstream high value chemicals producing units. Currently, methods for processing plastics generally use scale-limited modular equipment (leading to high capital cost), having poor heat transfer and long residence times during pyrolysis of plastics, resulting in formation of more aromatics and gas products, loss of hydrogen from the molecules leading to higher coke formation, and loss of part of feedstock as coke. More specifically, for a process of producing light olefins, BTX, and EB to be commercial and economically viable in a large volume process such as steam cracker or FCC the conversion process for converting solid plastic to liquid feedstock (for the above units) has to be scalable and continuous which also brings in an advantage of lower capital cost. As plastics have relatively low heat capacities, to mitigate coke formation, efficient heat transfer and short residence time in the pyrolysis step are preferred which leads to higher production of Hydrogen-rich liquid products. In addition, since coke and gas make are reduced, the loss of Carbon in these products is low, which translates to higher Carbon efficiency process for making liquid products from plastic conversion process.

Overall, while systems and methods for processing plastics to produce high valued chemicals exist, the need for improvements in this field persists in light of at least the aforementioned drawbacks for the conventional systems and methods. Further, a need exists for an alternative solution to the problem of pressure drop in fixed bed units for crude oil processing. It is also desirable to have a low cost/low capital expenditure intensity process for producing an FCC and Steam cracker feed.

Accordingly, Applicants have recognized a need for systems and methods to upgrade a hydrocarbon stream to a lower boiling point feed material. The present disclosure is directed to embodiments of such systems and methods.

### SUMMARY

A solution to the above mentioned problems associated with systems and methods for upgrading a hydrocarbon stream to a lower boiling point feed material is described. The solution resides in a system and a method for upgrading a hydrocarbon stream to a lower boiling point feed material. The method includes introducing a hydrocarbon stream including an alternative feedstock (e.g., depolymerized mixed plastic waste and/or plastic melt cracking product or plastics) and hydrogen to a first reactor. The method further includes operating a first reactor at a first pressure to produce a lower boiling point hydrocarbon feed material, a catalyst rich heavy hydrocarbon stream, and coke and operating a second reactor at a second pressure lower than the first pressure to produce olefins and aromatics, thereby ensuring the commercial viability of the method. Prior to introduction of the hydrocarbon stream to the first reactor, the stream may be pre-heated and/or flashed and/or coked. The addition of a slurry settler, when the first reactor is a slurry reactor, downstream of first reactor may prevent coke deposits from forming in the second reactor and may prevent pressure drops in the second reactor. Further, the slurry settler may allow for the re-use and recycling of a catalyst used in the first reactor, thus saving on costs and materials used (e.g., the catalyst). Such systems and methods may utilize low cost and/or, at least some, pre-existing equipment. Finally, each reactor may operate at low pressures, e.g., less than 100 barg in the first reactor and less than 40 barg in the second reactor and/or other pressure ranges as described herein, thereby resulting in higher conversion rates, lower cost, and/or reduced pressure drop.

Embodiments of the disclosure include a method for upgrading a hydrocarbon stream to a lower boiling point hydrocarbon feed material to produce olefins and aromatics at a high conversion rate and while preventing a pressure drop due to coke formation. The method may include introducing a hydrocarbon stream that includes an alternative feedstock to a pre-heater. The pre-heater may be configured to heat the hydrocarbon stream and thereby define a pre-heated hydrocarbon stream. The method may include supplying the pre-heated hydrocarbon stream with hydrogen to a first reactor. The method may include operating the first reactor at a first pressure and a temperature to produce a lower boiling point hydrocarbon feed material, a heavy hydrocarbon stream, and coke from the pre-heated hydrocarbon stream. The method may include transporting the heavy hydrocarbon stream and coke to a coke vessel. The method may include separating coke, in the coking vessel, from the heavy hydrocarbon stream to define a heavy hydrocarbon stream to prevent substantial plugging (e.g., pressure drop) due to coke formation and/or coke deposition during operation of a second reactor. The method may include transporting the lower boiling point hydrocarbon feed material from the first reactor and the coke-lean heavy hydrocarbon stream to the second reactor. The method may finally include operating the second reactor to produce olefins and aromatics from the lower boiling point hydrocarbon feed material and heavy hydrocarbon stream.

In another embodiment, the heavy hydrocarbon stream from the first reactor may include an amount of catalyst. In such embodiments, the method may include, prior to transporting the heavy hydrocarbon stream and coke to a coke vessel, transporting the catalyst rich heavy hydrocarbon stream and coke to a slurry settler. The method may also include separating, in the slurry settler, the catalyst rich heavy hydrocarbon stream into a catalyst rich stream and a heavy hydrocarbon stream including the coke.

In another embodiment, the method may include, prior to supplying the pre-heated hydrocarbon stream to the first reactor, flashing, in a flash drum, the pre-heated hydrocarbon stream to thereby form (1) volatile hydrocarbons with a boiling point less than or equal to 200° Celsius and (2) a remaining pre-heated hydrocarbon stream. The method may include supplying the remaining pre-heated hydrocarbon stream with hydrogen to the first reactor. The first reactor may be operated to produce a lower boiling point hydrocarbon feed material, a catalyst rich heavy hydrocarbon stream, and coke from the remaining pre-heated hydrocarbon stream. The method may include supplying the lower boiling point hydrocarbon feed material and/or heavy hydrocarbon stream (e.g., after catalyst separation) to the second reactor. The second reactor may further be operated to produce olefins and aromatics from the volatile hydrocarbons. In an embodiment, one or more additional second reactors may operate in parallel to the second reactor. The second reactor (e.g., the “first” second reactor) may accept or receive the volatile hydrocarbons from the flash drum and the lower boiling point hydrocarbon feed material while one of the one or more additional second reactors (e.g., the “second” second reactor) may accept the heavy hydrocarbon stream (e.g., after catalyst separation). As an example, the second reactor (e.g., the “first” second reactor) may be a steam cracker or a FCC unit and the one of the one or more additional second reactors (e.g., the “second” second reactor) may be a FCC unit.

In another embodiment, a pre-heater is heated to a temperature higher than that of the coking temperature of the pre-heated hydrocarbon stream and conveyed to a coking vessel along with hydrogen and then to the first reactor. The first reactor may at least partially crack the hydrocarbon stream from the coking vessel via one or more of thermal cracking and/or catalytic cracking. Further, during the thermal cracking and/or catalytic cracking, the first reactor may be operated at or with a temperature between about 250° Celsius and about 700° Celsius, with a residence time of less than 90 minutes, and/or with the first pressure in the first reactor less than or equal to 100 barg. In an embodiment, the temperature, residence time, and first pressure of the pre-heater and coking vessel may aid in the formation of coke. Such embodiments may minimize the coking in the first reactor by removing the coking components, as coke, before entering first reactor. Further, the first reactor may be a fixed bed, a slurry reactor, or an ebullated bed reactor.

In an embodiment, the first reactor is one of a continuous stirred reactor, a bubble column reactor, or a tubular reactor. The first reactor uses a dissolved catalyst, a dispersed or fixed bed catalyst or any combinations of these. The dissolved catalyst may be an organometallic compound of nickel (Ni), molybdenum (Mo), cobalt (Co) or other metal naphthenates or octanoates having hydrogenation activity or qualities. The dispersed or fixed bed catalyst may be an alkali metal hydroxide or oxide, Ni—Mo oxides or sulphides, Co—Mo oxides or sulphides, W—Mo oxides or sulphides on alumina or zeolites, or some combination having hydroprocessing and/or hydrogen transfer activity, e.g., including hydrocracking, hydrotreating, hydrogenation, and/or other reactions. Zeolites utilized may include ZSM-5, an X-type zeolite, a Y-type zeolite, a USY-zeolite, mordenite, faujasite, nano-crystalline zeolites, MCM mesoporous materials, SBA-15, a silico-alumino phosphate, a gallium phosphate, a titanophosphate, a molecular sieve, spent FCC catalyst, metal loaded ZSM-5 catalyst, metal loaded spent FCC catalyst, metal loaded aluminosilicate using Mg, Ni, Co or other transition metals or some combination thereof. In an embodiment, the method may further include introducing, prior to operating the first reactor, one or more of a dispersed catalyst and a dissolved catalyst to the first reactor. The method may also include, prior to introduction of the hydrocarbon stream to the pre-heater, injecting one or more of a dissolved catalyst or hydrogen or hydrogen containing gas into the hydrocarbon stream. The method may further include introducing one or more of a hydrocarbonaceous plastic stream or a hydrocarbonaceous wax stream to a depolymerization unit. The method may include generating, via the depolymerization unit, the alternative feedstock. Finally, the method may include injecting the alternative feedstock into a crude oil to define the hydrocarbon stream prior to introduction of the hydrocarbon stream to the pre-heater. The amount of alternative feedstock may be about 0.1% to about 5% of total weight of the hydrocarbon stream.

Embodiments of the disclosure include a system for upgrading crude oil to a lower boiling point hydrocarbon feed material. The system may include a feeding device. The feeding device may transport a hydrocarbon stream that includes an alternative feedstock. The system may include a first cracking unit that receives the hydrocarbon stream from the feeding device. The first cracking unit may be operable, at a first pressure, to partially crack the hydrocarbon stream via one or more of thermal cracking or catalytic cracking to produce a lower boiling point hydrocarbon feed material, a catalyst rich heavy hydrocarbon stream, and coke. The system may include a slurry settler that receives the catalyst rich heavy hydrocarbon stream and coke from the first cracking unit. The slurry settler may be operable to separate the catalyst from the catalyst rich heavy hydrocarbon stream and coke thereby defining a catalyst rich stream, a heavy hydrocarbon stream, and coke. The catalyst rich stream may be transported from the slurry settler for re-use or regeneration. The system may include a coke settler that receives the heavy hydrocarbon stream and coke from the slurry settler. The coke settler may be operable to separate hydrocarbons from coke in the heavy hydrocarbon stream, thereby defining particulate coke and another hydrocarbon stream. The system may include a second cracking unit that receives the lower boiling point feed material from the first cracking unit. The second cracking unit may be operable to produce olefins and aromatics.

In another embodiment, the system may include a flash drum that receives the pre-heated hydrocarbon stream. The flash drum operable to produce a volatile hydrocarbon stream with a boiling point less than or equal to 200° Celsius. The volatile hydrocarbon stream may be transported to the second cracking unit. A remaining pre-heated hydrocarbon stream may be transported to the first cracking unit.

In an embodiment, the system may include a coking vessel that receives the pre-heated hydrocarbon stream. The coking vessel may be operable to reduce coke in the pre-heated hydrocarbon stream. In an embodiment, the second cracking unit may additionally receive the another hydrocarbon stream from the coke settler. The second cracking unit may include one or more of a fluid catalytic cracking unit, a steam cracker unit, or a catalytic naphtha reformer unit. The second cracking unit may be a catalytic naphtha reformer unit. The first cracking unit (1) may receive the another hydrocarbon stream from the coke settler and (2) may be operable to further process the another hydrocarbon stream to extinction.

In another embodiment, the system may include a depolymerization unit to generate the alternative feedstock from one or more of a hydrocarbonaceous plastic stream or a hydrocarbonaceous wax stream. The system may include a guard bed to receive the another hydrocarbon stream prior to transport to production equipment. The guard bed may be operable to remove trace metals from the another hydrocarbon stream.

In another embodiment, the first catalytic unit may utilize a dissolved catalyst, a dispersed, a fixed bed catalyst, or some combination thereof. The dissolved catalyst may be an organometallic compound of nickel (Ni), molybdenum (Mo), cobalt (Co) or other metal naphthenates or octanoates having hydrogenation activity or qualities. The dispersed catalyst may be an alkali metal hydroxide or oxide, Ni—Mo oxides or sulphides, Co—Mo oxides or sulphides, W—Mo oxides or sulphides on alumina or zeolites, or some combination having hydroprocessing and/or hydrogen transfer activity, e.g., including hydrocracking, hydrotreating, hydrogenation, and/or other reactions. Zeolites utilized may include ZSM-5, an X-type zeolite, a Y-type zeolite, a USY-zeolite, mordenite, faujasite, nano-crystalline zeolites, MCM mesoporous materials, SBA-15, a silico-alumino phosphate, a gallium phosphate, a titanophosphate, a molecular sieve, spent FCC catalyst, metal loaded ZSM-5 catalyst, metal loaded spent FCC catalyst, metal loaded aluminosilicate using Mg, Ni, Co or other transition metals or some combination thereof, the catalyst configured to scavenge chlorides and enhance production of straight chain hydrocarbons. The first catalytic unit may include an additive to scavenge chlorides and one or more other halides. The additive may include one or more of oxides, carbonates, bicarbonates, hydroxides of alkali metals, alkali earth metals, or transition metals.

In an embodiment, the first catalytic unit may utilize an acidic catalyst to crack the hydrocarbon stream.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present disclosure can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present disclosure will become apparent from the following figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a system for upgrading a hydrocarbon stream to a lower boiling point feed material, according to embodiments of the disclosure;

FIG. 2A, FIG. 2B, FIG. 2C, FIG. 2D, and FIG. 2E show schematic diagrams of systems for upgrading a hydrocarbon stream to a lower boiling point feed material, according to embodiments of the disclosure;

FIG. 3 shows a schematic diagram of another system for upgrading a hydrocarbon stream to a lower boiling point feed material, according to embodiments of the disclosure;

FIG. 4 shows yet another schematic diagram of another system for upgrading a hydrocarbon stream to a lower boiling point feed material, according to embodiments of the disclosure;

FIG. 5A and FIG. 5B show schematic flowcharts for a method of processing a plastic, according to embodiments of the disclosure; and

FIG. 6 shows a controller for controlling the process for upgrading a hydrocarbon stream to a lower boiling point feed material, according to embodiments of the disclosure.

FIG. 7 shows results for boiling points for components in a product stream obtained in examples.

### DETAILED DESCRIPTION

As noted, crude oil may contain resins and asphaltenes that are difficult to convert and tend to coke during conversion leading to plugging of fixed bed hydroprocessing reactors. Currently, the different methods and systems for such conversions are costly and, as noted, tend to create coke, which may lead to added costs and downtime. The systems and methods described herein provide solutions to these problems Therefore, systems and methods to convert crude oil or a hydrocarbon stream including an alternative feedstock is described. As used herein, an “alternative feedstock” may include a hydrocarbonaceous wax stream, depolymerized mixed plastic waste, partially depolymerized mixed plastic waste, plastic melt, plastic melt cracking product, plastics, plastic pyoil, oligomers, and/or synthetic crude oil. Other alternative feedstock may be utilized. The crude oil may be mixed with depolymerized or melt cracked mixed plastic waste. The mixed plastic waste is a source of aromatics (e.g., such as when the mixed plastic waste about 10% to about 20% of aromatic containing polymers like PET and PS) which keep asphaltenes in solution to prolong their conversion. The mixed plastic waste with a low content of aromatics in polymer may also be a paraffinic alternate feed which may assist in crashing out the asphaltenes. In the embodiments described herein, the asphaltenes can be processed and can aid in the operations disclosed herein (e.g., in a slurry reactor, coking vessel, and/or fixed bed reactor). Such a solution is premised on a method of processing a hydrocarbon stream which may include an alternative feedstock injected with a dissolved catalyst and/or hydrogen. Such a mixture may be heated to a particular temperature, e.g., pre-heated.

A first reactor may be operated at a temperature and lower than normal pressure such that a heavy hydrocarbon stream including spent catalyst and a lower boiling point hydrocarbon feed material are produced. To reduce issues associated with coking in a downstream second reactor, the first reactor (e.g., a continuous stirred reactor, a bubble column reactor, a jet loop reactor, a tubular reactor, or a fixed bed reactor) may be operated to additionally produce coke. In other word, the first reactor may be configured to intentionally produce coke from the hydrocarbon stream. To further reduce issues associated with coking and other issues associated with high pressure conversion, the heavy hydrocarbon stream, including spent catalyst, and coke are transported to a slurry settler for separation of the catalyst from the heavy hydrocarbon stream. The slurry settler may be utilized when the first reactor is a slurry reactor or uses or produce a slurry. The catalyst may then be re-used or transported for regeneration or recycling. The remaining hydrocarbon stream may be transported to a coking vessel (e.g., one or more of a coke settler, coker, a coke remover, and/or other device, equipment, or component capable of forming or removing coke from a feed stream) to remove or reduce coke contained in the heavy hydrocarbon stream. Such a removal or reduction in coke allows the second reactor to operate at a lower than normal pressure and at appropriate temperatures, due to substantial coke reduction (e.g., based on the intentional forming of coke in the first reactor and/or elsewhere in the operations described herein). For example, a second reactor (e.g., a hydrotreater, fluid catalytic cracker (FCC), a steam cracker (SC), and/or a fixed bed reactor) may accept the reduced coke hydrocarbon stream for further processing. As noted, the feedstock may include mixed plastic waste (e.g., depolymerized or partially depolymerized mixed plastic waste), thereby further reducing costs. In some examples, the hydrocarbon stream may include about 0.1% to about 5% of depolymerized or partially depolymerized mixed plastic waste in relation to the total weight or content of the hydrocarbon stream. These and other non-limiting aspects of the present disclosure are discussed in further detail in the following sections.

### A. System for Upgrading a Hydrocarbon Stream

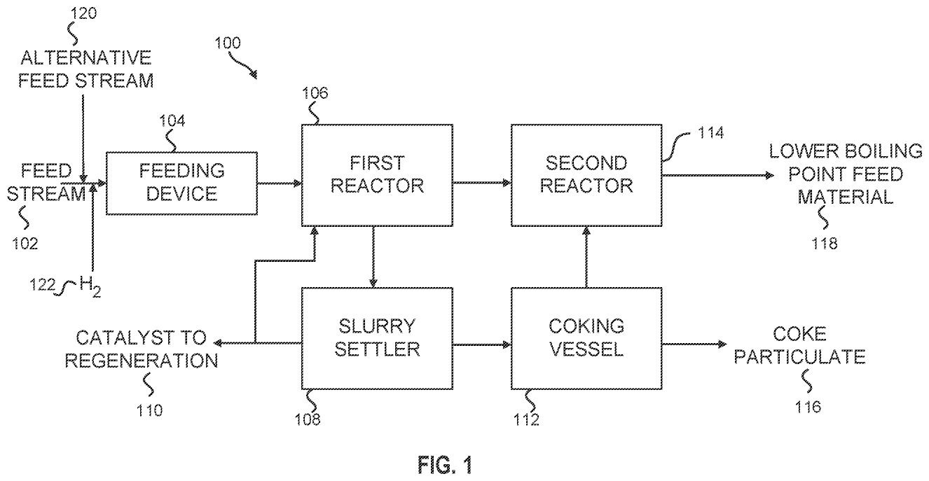

In embodiments of the disclosure, the system for upgrading a hydrocarbon stream may comprise a feeding device, a first reactor, a slurry settler, a coking vessel, and a second reactor. Additionally, separately, or in some combination thereof, other devices and/or units may be included. With reference to FIGS. 1 through 4, various schematic diagrams are shown for system 100, system 200A, system 200B, system 200C, system 300, and system 400, which are used for upgrading a hydrocarbon stream to a low boiling point hydrocarbon feed material.

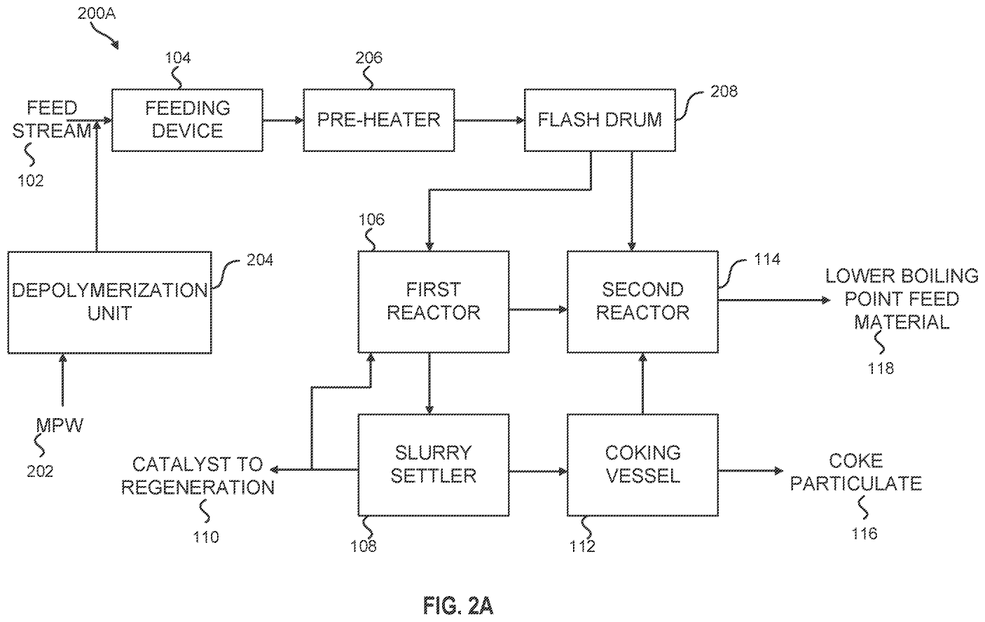

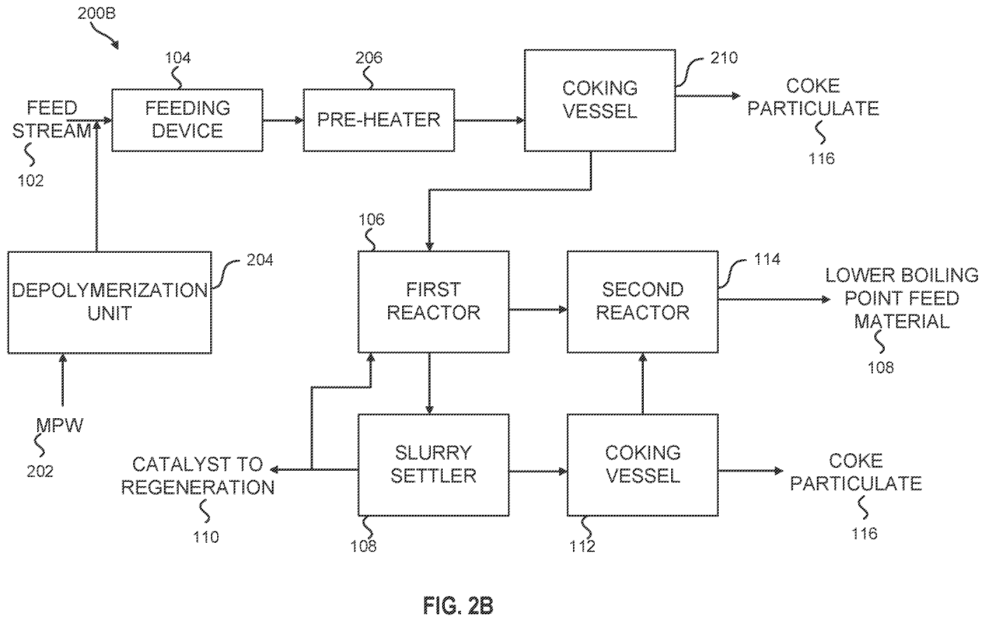

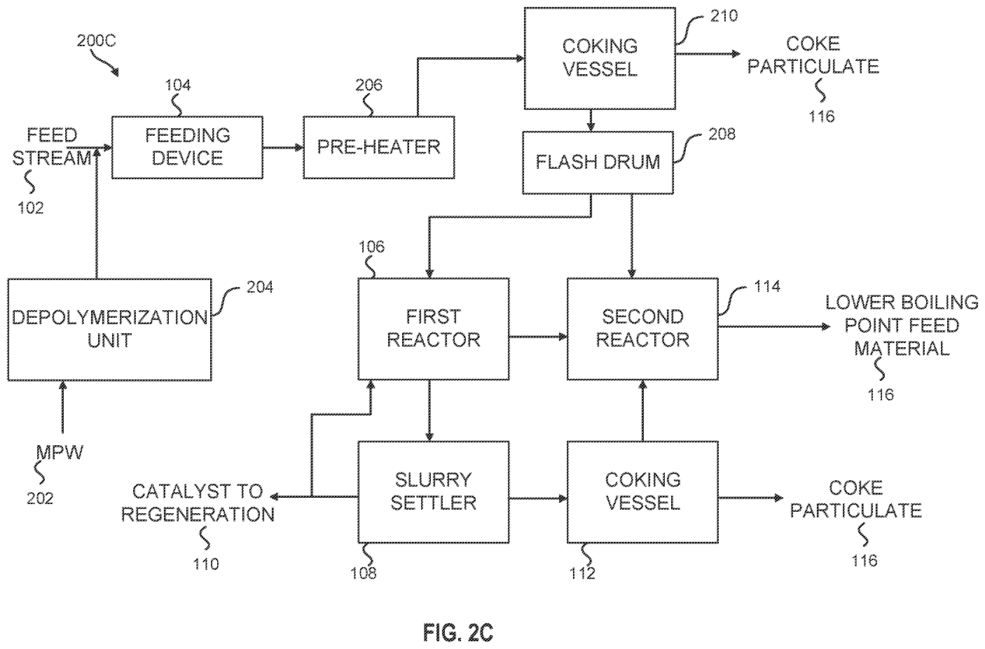

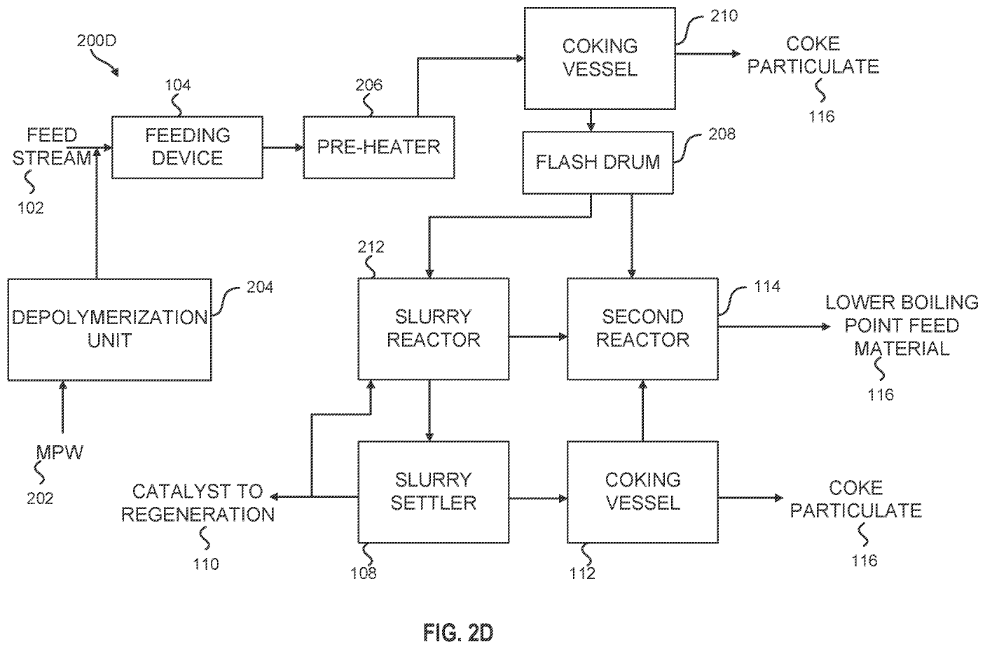

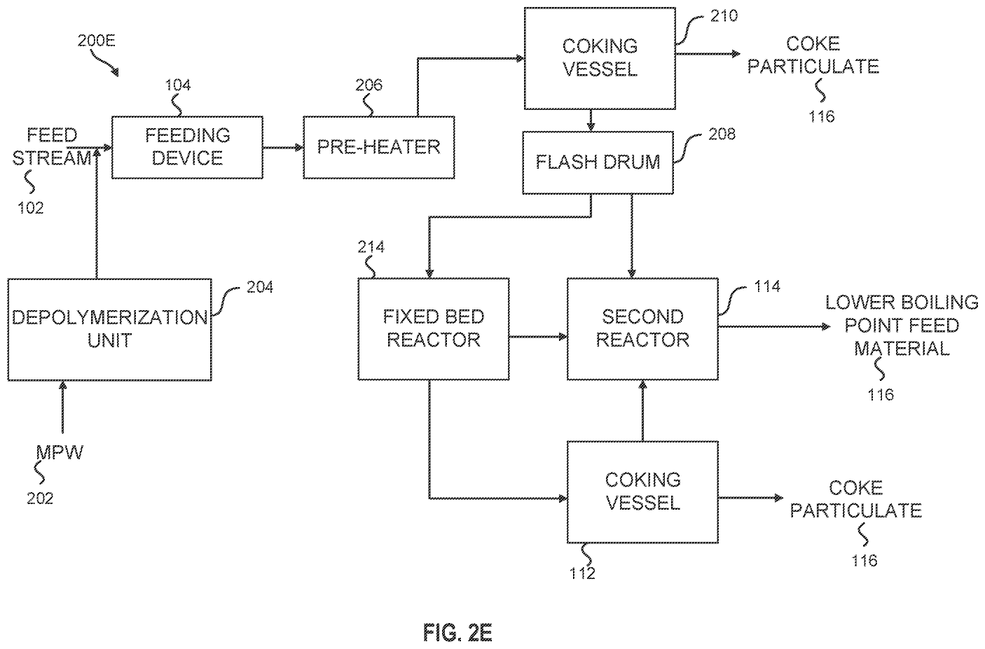

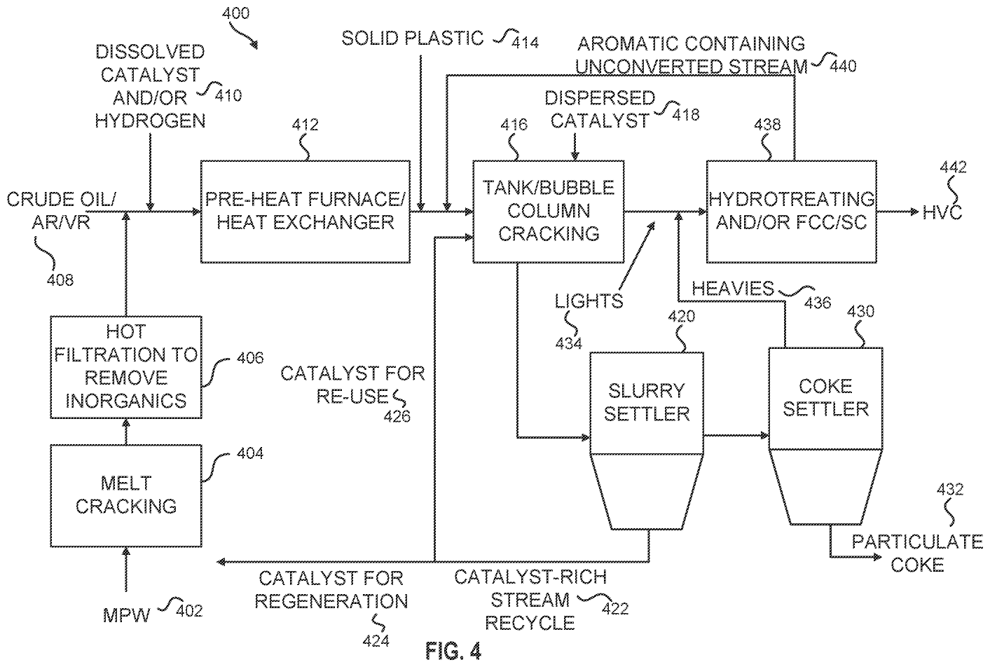

Referring to FIG. 1, system 100 includes feeding device 104 configured to feed or transport a feed stream 102, including, in some embodiments, an alternative feed stream 120 and/or hydrogen 122, to a first reactor 106. Feeding device 104 may be configured to combine and/or process various materials and/or fluids. The feeding device 104, for example may be configured to depolymerize or partially depolymerize plastic, such as mixed plastic waste, and form a hydrocarbonaceous wax that has an average molecular weight of 20 to 50 times lower than the average molecular weight of components of the plastic. In another embodiment, the depolymerization or partial depolymerization of plastic may occur in devices, components, equipment, or systems upstream of the feeding device 104 (e.g., as illustrated in FIGS. 2A-2C and 4). In yet other embodiments, the feeding device 104 may mix or combine depolymerized or partially depolymerized plastic, other alternative feedstock, crude oil, additives, catalyst, or some combination thereof prior to transport to the first reactor 106. The plastic may include one or more polyolefins, one or more polystyrenes, one or more polyesters, one or more polyvinyl chlorides, one or more polyamides, or some combination thereof. In embodiments, other fluids and/or liquids are fed into the feeding device 104 and transported to the first reactor 106. The fluid and/or liquids may include various types of crude oil, synthetic crude oil, bio or renewable oil, recycled streams, alternative feeds, or some combination thereof. In an embodiment, the amount of depolymerized plastic or partially depolymerized plastic may comprise about 0.1% to about 5% of the total weight or content of the hydrocarbon stream output from the feeding device 104.

In an embodiment, a dissolved and dispersed or fixed bed catalyst, a dissolved catalyst, a dispersed or fixed bed catalyst, hydrogen, or some combination thereof may be fed into feeding device 104 and mixed or combined with the other fluids entering the feeding device 104 or may be injected into the hydrocarbon stream prior to entering the first reactor 106. The dissolved and dispersed or fixed bed catalyst, dissolved catalyst, dispersed or fixed bed catalyst, hydrogen, or combinations thereof aid in deep cracking, deep hydrogenation, and efficient hydrogen transfer. Such examples aid in converting difficult to convert fluids, which may otherwise not convert. The dissolved catalyst may be an organometallic compound of nickel (Ni), molybdenum (Mo), cobalt (Co) or other metal naphthenates or octanoates having hydrogenation activity or qualities. The dispersed catalyst may be an alkali metal hydroxide or oxide, Ni—Mo oxides or sulphides, Co—Mo oxides or sulphides, W—Mo oxides or sulphides on alumina or zeolites, or some combination having hydroprocessing and/or hydrogen transfer activity, e.g., including hydrocracking, hydrotreating, hydrogenation, and/or other reactions. Zeolites utilized may include ZSM-5, an X-type zeolite, a Y-type zeolite, a USY-zeolite, mordenite, faujasite, nano-crystalline zeolites, MCM mesoporous materials, SBA-15, a silico-alumino phosphate, a gallium phosphate, a titanophosphate, a molecular sieve, spent FCC catalyst, metal loaded ZSM-5 catalyst, metal loaded FCC catalyst, or some combination thereof. In embodiments of the disclosure, the dissolved and dispersed or fixed bed catalyst, dissolved catalyst, dispersed or fixed bed catalyst, or any other additive or catalyst used may be configured to scavenge chlorides and enhance production of straight chain hydrocarbons over branched hydrocarbons. Metal loaded aluminosilicates help in scavenging chlorides as well as enhancing straight chain hydrocarbons over branched hydrocarbons. The naphthenates or octanoates decompose to the respective metal oxides under depolymerization condition which can scavenge any chlorides present in the feed stream 102 as hydrogen chloride (HCL). Further, examples of such catalysts may be 15% Mg on ZSM-5 commercial FCC additive, 15% Mg with 8% Nickel on ZSM-5 commercial FCC additive, a combination of spent FCC catalyst from a refinery unit with an added 15% Mg on ZSM-5 commercial FCC additive, and other combination as will be understood by a person skilled in the art.

In an embodiment, if the feeding device 104 includes a depolymerization unit, then the feeding device 104 may include an extruder, an auger, a screw feeder, a piston in a feed chamber, a kneader reactor, a block and feed type of manifold, stirred tank reactors, or combinations thereof. Such a feeding device 104 may be a continuous feeding device. Further embodiments are discussed below in relation to FIGS. 2A-2C and 4.

In an embodiment, the feeding device 104 may include a pre-heater. The pre-heater may be a device or system separate from the feeding device 104. The pre-heater may be positioned upstream or downstream of the feeding device 104. The pre-heater may heat the feed stream 102 to a particular or specified temperature.

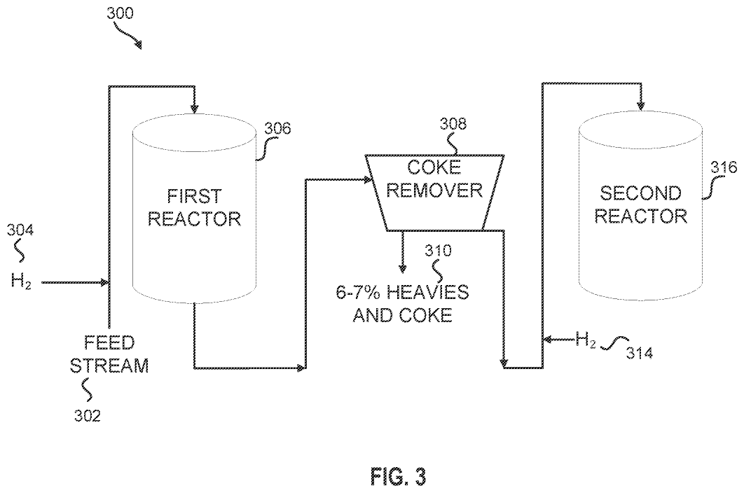

The feeding device 104, as noted, may provide a feed stream 102 to a first reactor 106. The first reactor 106 may be a continuous stirred reactor, a bubble column reactor, a jet loop reactor, or a tubular reactor. For the specific cases of FIG. 2B, 2C and FIG. 3, the first reactor can also be a fixed bed reactor. During operation, the first reactor 106 may perform a hydrocracking or partial hydrocracking operation. Such an operation may include a pressure of less than or equal to 125 barg, less than or equal to 100 barg, less than or equal to 75 barg, about 125 barg to about 40 barg, about 100 barg to about 40 barg, about 75 barg to about 40 barg, or some combination thereof. Further, the first reactor 106 may be, during operation of the first reactor 106, at a temperature of about 200° Celsius to about 700° Celsius, about 250 Celsius to about 700 Celsius, about 300° Celsius to about 700° Celsius, about 400° Celsius to about 700° Celsius, about 200° Celsius to about 600° Celsius, about 300° Celsius to about 600° Celsius, about 400° Celsius to about 600° Celsius, or about 280° Celsius to about 500° Celsius. Such a pressure, lower than conventional process operations, and temperature, higher than conventional process operations, result in significantly higher conversions and lower cost. In another embodiment, the first reactor 106 may be configured to intentionally form coke.

In another embodiment, the first reactor 106 may be a catalytic cracking unit or a catalytic hydrocracking unit. Such a unit may utilize a catalytic hydrocracking operation. Such an operation may increase saturates in a feed stream 102 (e.g., crude oil with an alternative feedstock) causing asphaltenes to crash out of the feed stream 102, in addition to the free coke particles. The coke particles and/or asphaltenes may be filtered out of the feed stream prior to further processing (e.g., the second reactor 114), as described herein.

The operation of the first reactor 106 may produce a lower boiling point hydrocarbon feed material, a catalyst rich heavy hydrocarbon stream, and/or coke or coke particulates from the pre-heated hydrocarbon. The lower boiling point hydrocarbon feed material may be transported to a second reactor 114. The catalyst rich heavy hydrocarbon stream may be transported to a slurry settler 108. In an embodiment, the coke may be transported, in addition to the catalyst rich heavy hydrocarbon stream, to a slurry settler 108. In another embodiment, the coke may be transported from the system 100. In an embodiment, the system 100 may not include a slurry settler 108. In such embodiments, the first reactor 106 may be a fixed bed reactor and coke may be removed from the feed stream prior to entering first reactor 106.

The slurry settler 108 may separate the catalyst from the catalyst rich heavy hydrocarbon stream. The slurry settler 108 may perform such a separation during particular time intervals. For example, the residence or holdup time of the slurry settler 108 (e.g., the amount of time that the catalyst rich heavy hydrocarbon stream stays or resides in the slurry settler 108) may be less than or equal to 15 minutes, about 3 to about 15 minutes, about 4 to about 15 minutes, about 5 to about 15 minutes, about 10 to about 15 minutes, about 3 to about 10 minutes, about 4 to about 10 minutes, about 5 to about 10, about 3 to about 5 minutes, or about 4 to about 5 minutes. The slurry settler 108 may as a three-phase system. In such an embodiment, when steam is used in the first reactor 106, the catalyst may be recycled, while a water layer, along with coke and/or crashed out asphaltenes, may be transported to the coking vessel 112. The water, including the coke and/or crashed out asphaltenes, may flow from the coking vessel 112 as a bottom stream, while hydrocarbons may flow from the coking vessel 112 as a top stream.

The catalyst rich heavy hydrocarbon stream may include inorganic material, catalyst, and/or coke. In such examples, the catalyst may have a high tendency to settle quickly, while the inorganic material and/or coke may be well dispersed in the catalyst rich heavy hydrocarbon stream and settles slowly. The slurry settler 108 may utilize the difference in the rate of settling between the inorganic material and/or coke and catalyst to separate the catalyst from the catalyst rich heavy hydrocarbon stream by withdrawing a bottom stream, the bottom stream rich in catalyst, as a slurry from the catalyst rich heavy hydrocarbon stream and side-stream rich in inorganic material and/or coke, the side stream including a majority of the remaining heavy hydrocarbon stream, in addition to coke and/or other inorganic materials. In an embodiment, the catalyst rich heavy hydrocarbon stream may include an amount of dispersed and/or dissolved catalyst. The amount of catalyst in the catalyst rich heavy hydrocarbon stream may be about 1% to about 5%, about 1% to about 10%, about 1% to about 15%, about 5% to about 10%, about 5% to about 15%, or about 15% of the total weight or amount of the catalyst rich heavy hydrocarbon stream.

The settled catalyst in the slurry settler 108 may be recycled back into the first reactor 106 and/or sent for regeneration and/or reuse/purge 110. The inorganic material and/or coke rich heavy hydrocarbon stream from the slurry settler 108 may be fed to a coking vessel 112 or a coking unit to reject heteroatoms and coke from the inorganic material and/or coke rich heavy hydrocarbon stream. Optionally, the inorganic material and/or coke rich stream from the slurry settler 108 may be fed to a distillation unit where the distillation bottom, rich in inorganic material/coke, may be disposed or burned as fuel.

Recovered hydrocarbons from the coking vessel 112 may then be introduced into the second reactor 114 so that the stream may be combined with the lower boiling point hydrocarbon feed material from the first reactor 106 to generate an upgraded feed, e.g., a lower boiling point hydrocarbon feed material 118, for further use in downstream equipment. In an embodiment, the lower boiling point hydrocarbon feed material 118 may have a boiling point less than or equal to 350° Celsius. In an embodiment, 80% of the lower boiling point hydrocarbon feed material 118 may have a boiling point of less than or equal to 150° Celsius.

The second reactor 114 may be a hydrotreating or partial hydrocracking unit. In such embodiments, the second reactor 114 may be operated at a temperature of about 300° Celsius to about 500° Celsius or about 400° Celsius to about 430° Celsius. The second reactor 114 may be operated with a residence time of less than or equal to 2 hours or less than or equal to 1 hour. The second reactor 114 may operate at a catalyst loading of 10% or less or 5% or less. Finally, the second reactor 114 be operated with a pressure of 100 barg or less, Hydrogen to Hydrocarbon ratio of 400 to 3000 on feed to the partial hydrocracking unit. The catalyst employed in the second reactor 114 may include one or more of the same catalysts described above. The second reactor 114 may include or may be a hydrotreating unit, a steam cracking unit, a FCC unit or combinations thereof. In another embodiment, the second reactor 114 may be a steam cracker unit. In such an embodiment, the steam cracker may be operated at about 750° Celsius to about 900° Celsius. In yet another embodiment, the second reactor 114 may be an FCC unit. In such embodiments, the second reactor 114 may be operated at 400° Celsius to 750° Celsius.

In embodiments of the disclosure, feeding device 104 may include a devolatization extruder. The devolatization extruder may comprise gas withdrawal pipelines with a heater control disposed along the length thereof. In embodiments of the disclosure, the withdrawal pipelines may be in fluid communication with one or more condensers configured to condense gas product from the extruder body. Uncondensed portion of the gas product, in embodiments, may be scrubbed, utilized as a cracker feedstock in reactor units as the gas may contain C1 to C4 hydrocarbons, or combusted as a fuel e.g., in process unit furnaces. In embodiments of the disclosure, the devolatization extruder contains screws comprising a screw element including a left handed screw element, a right handed screw element, a neutral screw element, a kneading screw element, a conveying screw element, or combinations thereof.

According to embodiments of the disclosure, an outlet of feeding device 104 is in fluid communication with an inlet of the first reactor 106, such that a hydrocarbon feed stream including an alternative feedstock, e.g., a hydrocarbonaceous wax stream flows from feeding device 104 into the first reactor 106. In embodiments, a cracking unit (e.g., such as the depolymerization unit 204 of FIGS. 2A through 2C) is configured to crack components of a hydrocarbonaceous wax stream or other depolymerized or partially depolymerized mixed plastic waste (MPW) to be added to the feed stream 102, the feed stream 102 utilized to produce a lower boiling point hydrocarbon feed material 118 and a catalyst rich heavy hydrocarbon stream. As noted, the second reactor 114 may comprise a fixed bed reactor, a fluidized bed reactor, a rotary kiln, or other type of reactor as will be understood by a person skilled in the art. A fixed bed reactor may comprise a solid catalyst. Since the coke may be intentionally formed and removed from a hydrocarbon stream prior to introduction to the fixed bed reactor, the fixed bed reactor may exhibit substantially less down time (e.g., due to coking or cleaning/removing coke formed in the fixed bed reactor) and/or temperature fluctuations. A fluidized bed reactor may comprise the solid catalyst. In embodiments of the disclosure, first reactor 106 includes one or more continuous stirred tank reactors in fluid communication with a distillation column and or a gas-liquid or gas/liquid-liquid separator. In embodiments and as noted, the first reactor 106 may comprise one or more tubular reactors. In embodiments, first reactor 106 and feeding device 104 are connected via a temperature controlled duct. In embodiments of the disclosure, the feed stream 102 is suitable as a feedstock for a steam cracking unit and/or a catalytic cracking unit.

Referring to FIGS. 2A through 2E, the system 200A through 200E may include a depolymerization unit 204. The depolymerization unit 204 may accept mixed plastic waste (MPW) 202. The depolymerization unit 204 may depolymerize or partially depolymerize the MPW 202. The resulting product may be transferred to the feeding device 104. In an embodiment, depolymerization unit 204 may include an extruder, an auger, a screw feeder, a kneader, a stirred tank reactor, a rotary kiln, a piston in a feed chamber, a block and feed type of manifold, or combinations thereof. The depolymerization unit 204 may be a continuous feeding device. Further, the depolymerization unit 204 may be equipped with an automated valving system. The automated valving system may be configured for gas pressurized discharge being operated in a timer-based pulse mode for mimicking continuous feeding.

The systems 200A through 200E may further include a pre-heater 206. The pre-heater 206 may heat, as noted, the feed stream 102 to a particular or specified temperature. The pre-heater 206 may be a heated or temperature-controlled duct or other heating device, as will be understood by a person skilled in the art. The systems 200A and 200E may further include a flash drum 208. The flash drum 208 may briefly heat or flash the pre-heated feed stream to a high temperature. Such a temperature may cause the feed stream to separate into volatile hydrocarbons with a boiling point less than 200° C. and a remaining pre-heated hydrocarbon stream The volatile hydrocarbons with a boiling point less than 200° C. may be transported directly to the second reactor 114, while the remaining pre-heated hydrocarbon stream may be transported to the first reactor 106. Rather than occurring in a flash drum 208, such an operation may occur in the pre-heater 206, the feeding device 104, or at some other point in systems 200A through 200E.

The systems 200B-200E may also include a coking vessel 210 to remove coke particulate 116 from the feed stream 102. In such an example, the pre-heater 206 may heat the feed stream 102 to a temperature higher than that of the coking vessel 210 and/or the first reactor 106. After coke particulate is removed from the feed stream 102, additional hydrogen and dissolved catalyst may be injected into the reduced coke feed stream, as the reduced coke feed stream is transported to the first reactor 106. In such an embodiment, the first reactor 106 may be configured to form coke, the coke to be transported to a coking vessel 112 for removal, thus further reducing the amount of coke from the reduced coke feed stream. In an embodiment, the first reactor 106 may be a slurry reactor 212, as depicted in FIG. 2D. The slurry reactor 212 may transport the catalyst rich heavy hydrocarbon and coke to the slurry settler 108. In another embodiment, the first reactor 106 may be a fixed bed reactor 214. In such examples, an amount of coke may be removed from a stream prior to transport to the fixed bed reactor 214. The coke may be generated by heating the stream to a selected temperature in the coking vessel 210 and then removed from the stream. Coke formation may be aided via pre-heating in the pre-heater 206. As such, the fixed bed reactor 214 may operate such that less than a typical amount of coke is formed or, in some embodiments, such that no coke is formed.

Referring to FIG. 3, the system 300 may include a first reactor 306 to receive a feed stream 302 injected with hydrogen 304. The first reactor 306 may partially crack the feed stream 302. The resulting output may include a light hydrocarbon stream and a heavy hydrocarbon stream. The light hydrocarbon stream may be transported directly to the second reactor. The heavy hydrocarbon stream may be transported to the coke remover 308. The coke remover 308 may remove coke or coke particulate from the heavy hydrocarbon stream. The amount of coke or coke particulate and other heavies removed from the heavy hydrocarbon stream may equal to about 6% to about 7% of the weight or content of the total heavy hydrocarbon stream. After the removal of the coke or coke particulate and other heavies, the remaining heavy hydrocarbon stream may be transported to the second reactor 316 for further processing into aromatics and olefins.

In another embodiment, the first reactor 306 (e.g., a continuous stirred reactor, a bubble column reactor, a jet loop reactor, or a tubular reactor) may be configured to form coke in the feed stream 302. In a further embodiment, the first reactor 306 may form a substantial amount of coke from the feed stream 302. The coke may then be removed via the coke remover 308 or another downstream coke port. In such embodiments, the second reactor 316 may be a hydrotreater, fluid catalytic cracker (FCC), a steam cracker (SC), and/or a fixed bed reactor. If, for example, a fixed bed reactor processes a feed stream with coke or without coke removed from the feed stream, the fixed reactor may have a shorter maintenance timeframe and/or temperature control issues (e.g., operating temperature may increase overtime). Since, in the embodiments described herein, coke in the feed stream 302 may be intentionally formed and removed prior to transport to the second reactor 316, formation of coke or substantial amounts of coke may be prevented in the second reactor 316. Further, the second reactor 316 may have longer maintenance timeframes and/or increased operating temperature consistency. Further still, the removal of coke may reduce any pressure drop caused by the formation of coke in the second reactor 316.

Referring to FIG. 4, a system 400 may include a pre-heat furnace or heat exchanger 412 to heat an incoming hydrocarbon stream. The hydrocarbon stream may include crude oil/Atmospheric residue (AR)/vacuum residue (VR) 408, depolymerized or partially depolymerized MPW 402, a dissolved catalyst and/or hydrogen 410, or some combination thereof. The depolymerized or partially depolymerized MPW 402 may be produced via a melt cracking unit 404. After the MPW 402 passes through the melt cracking unit 404, the resulting product may pass through hot filtration to remove inorganics 406.

The resulting hydrocarbon stream may be heated in the pre-heat furnace or heat exchanger 412 to a temperature higher than that of the operating temperature of the tank/bubble column cracking unit 416. After pre-heating, solid plastic 414 may be added to the pre-heated hydrocarbon stream. The resulting hydrocarbon stream may be transported to the tank/bubble column cracking unit 416 for cracking or partial cracking. A dispersed catalyst 418 may optionally be added to the tank/bubble column cracking unit 416.

The tank/bubble column cracking unit 416 may produce lights 434, which may be directly transferred to the hydrotreating and/or FCC/SC unit 438. The tank/bubble column cracking unit 416 may also produce a catalyst rich heavy hydrocarbon stream and an amount or substantial amount of coke, which may be transferred to a slurry settler 420. The slurry settler 420 may separate the catalyst from the catalyst rich heavy hydrocarbon stream thereby forming a catalyst-rich stream for recycle 422. At least a portion of the catalyst may be transported for re-use at 426. The remaining catalyst may be transported for regeneration at 424.

The remaining heavy hydrocarbon stream and coke may be transported from the slurry settler 420 to the coke settler 430. The coke settler 430 may separate particulate coke 432 from the heavy hydrocarbon stream. The remaining coke reduced heavy hydrocarbon stream, e.g., heavies 436, may be transported to the hydrotreating and/or FCC/SC unit 438. The hydrotreating and/or FCC/SC unit 438 may be operated to produce high value chemicals 442 and/or olefins and aromatics. Any aromatic containing unconverted stream 440 may be transported back to the tank/bubble column cracking unit 416 for further processing. In an embodiment, aromatic containing unconverted streams and/or other heavy streams (e.g., aromatic containing unconverted stream 440) may be processed to extinction (e.g., continuously fed back to the pre-heated feed stream).

In another embodiment, any of the systems 100, 200A-200C, 30, and 400 described herein may include one or more guard beds installed upstream and/or downstream either of the reactors. The guard beds may be configured to remove metal and/or non-metal components from hydrocarbon streams or feed streams. The one or more guard beds may comprise alumina with a high surface area as an adsorbent. The alumina of the guard beds may have a surface area from 50 m²/g to 400 m²/g and all ranges and values therebetween.

### B. Method for Upgrading a Hydrocarbon Stream

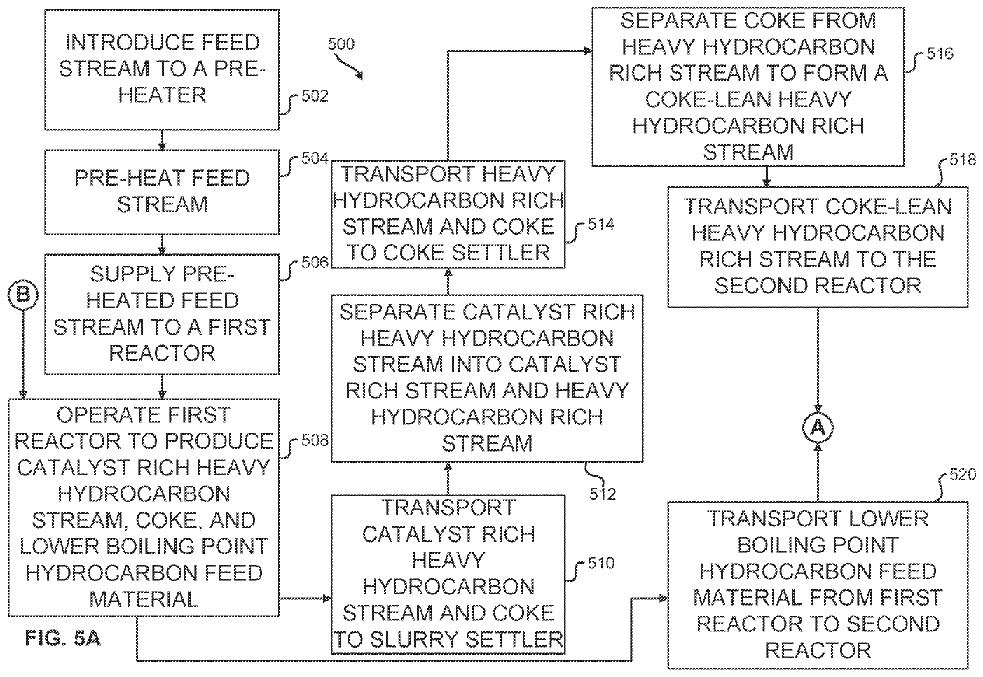

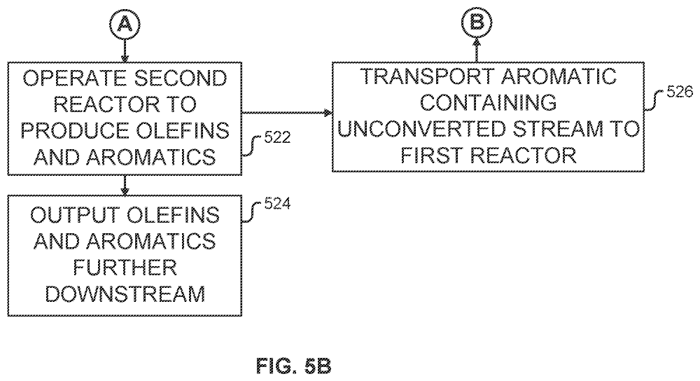

FIGS. 5A and 5B, illustrate flow diagrams upgrading a hydrocarbon stream to a lower boiling point hydrocarbon feed material, according to an embodiment. The method is detailed with reference to system 100 of FIG. 1. Other systems, such as system 200A, system 200B, system 200C, system 300, and/or system 400, may be utilized in relation to the method 500. The order in which the operations are described is not intended to be construed as a limitation, and any number of the described blocks may be combined in any order and/or in parallel to implement the methods.

At block 502, a feed stream 102 may be introduced to a pre-heater. The feed stream 102 may be transferred to another component or device capable of pre-heating the feed stream 102. In an example, the feed stream 102 may include a crude oil and an alternative feedstock. The alternative feedstock may include depolymerized or partially depolymerized MPW. Other additives or catalysts may be added to the feed stream 102 prior to or after introduction to the pre-heater.

At block 504, the pre-heater may heat the feed stream to a temperature greater than or equal to 350° C. and/or to a temperature greater than that of the operating temperature of the first reactor 106 and/or second reactor 114. The pre-heater may be a furnace or other heat exchanger. The pre-heater may be one or more furnace and/or heat exchangers.

At block 506, the pre-heated feed stream may be supplied or transported to a first reactor 106. The pre-heated feed stream may be supplied or transported to the first reactor 106 as a continuous stream.

At block 508, the first reactor 106 may be operated to produce a catalyst rich heavy hydrocarbon, coke, and a lower boiling point hydrocarbon feed material. Operation of the first reactor 106 may be a catalytic cracking or partial cracking operation. The first reactor 106 may be operated at a temperature between about 200° C. to about 700° C. Further, the first reactor 106 may be operated at less than or equal to 100 barg. Finally, the residence of time of the first reactor 106 may be less than about an hour.

At block 510, after the operation of the first reactor 106, the catalyst rich heavy hydrocarbon and coke may be transported to a slurry settler 108. At block 512, the slurry settler 108 may separate the catalyst rich heavy hydrocarbon into a catalyst rich stream and a heavy hydrocarbon stream, including coke. The residence time for such an operation may be between 1 to 15 minutes. The catalyst rich stream may be transported back to the first reactor 106 and/or to another device, component, or system for regeneration of the catalyst in the catalyst rich stream.

At block 514, the heavy hydrocarbon stream and coke may be transported from the slurry settler 108 to a coking vessel 112. At block 516, the coking vessel 112 may separate coke or coke particulate from the heavy hydrocarbon stream. The coking vessel 112 may further form a coke-lean or reduced coke heavy hydrocarbon stream. At block 518, the coke-lean or reduced coke heavy hydrocarbon stream may be transported to the second reactor 114.

At block 520, the lower boiling hydrocarbon feed material may be transported to the second reactor 114. In other words, after operation of the first reactor 106, a lower boiling hydrocarbon feed material may be formed. The lower boiling hydrocarbon feed material may be transported from the first reactor 106 to the second reactor 114.

At block 522, the second reactor 114 may be operated to produce olefins and aromatics. Operation of the second reactor 114 may be a catalytic cracking or partial cracking operation. The second reactor 114 may be operated at a temperature between about 200° C. to about 700° C. Further, the second reactor 106 may be operated at less than or equal to 40 barg. Finally, the residence of time of the second reactor 106 may be less than about an hour.

At block 524, the operation of the second reactor 114 may produce olefins and aromatics. The output olefins and aromatics may be transported further downstream for processing. At block 526, any aromatics containing an unconverted stream may be transported back to the first reactor 106.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

### C. Controller for Upgrading a Hydrocarbon Stream

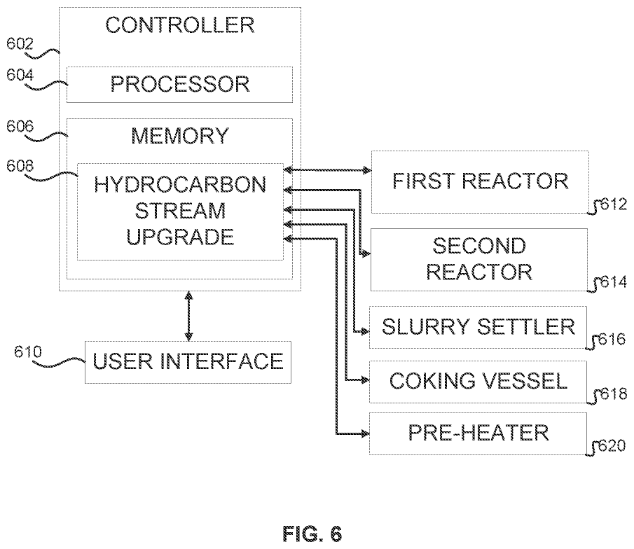

FIG. 6 is a simplified diagram illustrating a control system for managing a system for upgrading a hydrocarbon stream, according to an embodiment of the disclosure. The control system, as described herein, may be a controller 602, one or more controllers, a PLC, a SCADA system, a computing device, and/or other components to manage the upgrading process. The instructions may correspond to the steps described for method 500. The controller 602 may include one or more processors (e.g., processor 604) to execute instructions stored in memory 606. In an example, the memory 606 may be a machine-readable storage medium. As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. As noted, the memory 606 may store or include instructions executable by the processor 604. As used herein, a “processor” may include, for example one processor or multiple processors included in a single device or distributed across multiple computing devices. The processor 604 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

The instructions may include an instruction 608 to manage the hydrocarbon stream upgrade. In such examples, various details regarding the operation may be entered at the user interface 610 or may be preset or stored as presets in the memory 606. Such details may include a type of crude oil, a type of MPW, an amount of crude oil, an amount of depolymerized or partially depolymerized MPW to mix with the crude oil, an amount of dispersed and/or dissolved catalyst to add during the operation, a time when each such catalysts are to be added, an amount of hydrogen and a time to add such an amount of hydrogen to the operation, an amount of catalyst to transport back to the first reactor 612, an operating temperature of the first reactor 612, an operating temperature of 616, a residence time of the slurry settler 616, a residence time of the coking vessel 618, an operating temperature of the pre-heater 620, and/or any other details relevant to the operation. As the operation or process, for example, as described in method 500, begins, the controller 602 may ensure the proper temperatures, residence times, and amounts are utilized. For example, a specified or particular amount of the crude oil and depolymerized MPW may be mixed for a particular operation. The controller 602, using various sensors and other data may ensure that the proper amounts are mixed. Further, such a mixture may require a particular residence time, operating pressure, and operating temperature for catalytic cracking. As such, the controller 602 may ensure that the first reactor 612 operates at such parameters.

The controller 602 may determine or measure such parameters based on various sensors or meters disposed throughout the systems described herein. For example, the controller 602 may connect to and receive data from temperature sensors, pressure sensors, flow meters, and/or other sensors to measure other characteristics (e.g., composition, density, etc.) positioned at the first reactor 612, the second reactor 614, the slurry settler 616, the coking vessel 618, and/or the pre-heater 620.

As part of the disclosure of the present disclosure, specific examples are included below. The examples are for illustrative purposes only and are not intended to limit the disclosure. Those of ordinary skill in the art will readily recognize parameters that can be changed or modified to yield essentially the same results.

What is claimed is:

1. A method for upgrading a hydrocarbon stream to a lower boiling point hydrocarbon feed material to produce olefins and aromatics at a high conversion rate and while preventing a pressure drop due to coke formation, the method comprising:
introducing a hydrocarbon stream that includes an alternative feedstock to a pre-heater, the pre-heater configured to heat the hydrocarbon stream and thereby define a pre-heated hydrocarbon stream;
supplying the pre-heated hydrocarbon stream to a first reactor;
operating the first reactor at a first pressure and a temperature to produce a lower boiling point hydrocarbon feed material, a heavy hydrocarbon stream, and coke from the pre-heated hydrocarbon stream;
transporting the heavy hydrocarbon stream and coke to a coke vessel;
separating the coke, in the coke vessel, from the heavy hydrocarbon stream to prevent substantial coke formation during operation of a second reactor;
transporting the lower boiling point hydrocarbon feed material from the first reactor and the heavy hydrocarbon stream to the second reactor; and
operating the second reactor to produce olefins and aromatics from the lower boiling point hydrocarbon feed material and heavy hydrocarbon stream.

2. The method of claim 1, wherein the heavy hydrocarbon stream from the first reactor includes an amount of catalyst, and
further comprising, prior to transporting the heavy hydrocarbon stream and coke to a coke vessel:
transporting the catalyst rich heavy hydrocarbon stream and coke to a slurry settler;
separating, in the slurry settler, the catalyst rich heavy hydrocarbon stream into a catalyst rich stream and a heavy hydrocarbon stream including the coke.

3. The method of claim 1, further comprising:
prior to supplying the pre-heated hydrocarbon stream to the first reactor, flashing, in a flash drum, the pre-heated hydrocarbon stream to thereby form (1) volatile hydrocarbons with a boiling point less than or equal to 200° Celsius and (2) a remaining pre-heated hydrocarbon stream with a boiling point greater than or equal to 200° Celsius;
supplying the remaining pre-heated hydrocarbon stream to the first reactor, wherein the first reactor is operated to produce a lower boiling point hydrocarbon feed material, a catalyst rich heavy hydrocarbon stream, and coke from the remaining pre-heated hydrocarbon stream; and
supplying the volatile hydrocarbons to the second reactor, the second reactor further operated to produce olefins and aromatics from the volatile hydrocarbons.

4. The method of claim 1, wherein the pre-heater is heated to a temperature higher than that of the coking vessel and the first reactor.

5. The method of claim 1, wherein, the first reactor at least partially cracks the hydrocarbon stream via one or more of thermal cracking or catalytic cracking, and wherein, during cracking, the first reactor is operated at a temperature between about 250° Celsius and about 700° Celsius, with a residence time of less than 90 minutes, and with the first pressure in the first reactor less than or equal to 100 barg, and wherein the temperature, residence time, and first pressure aid in the formation of coke.

6. The method of saint 1, wherein the first reactor is one of a continuous stirred reactor, a bubble column reactor, or a tubular reactor.

7. The method of claim 1, wherein the first reactor includes one or more of dispersed catalyst or a dissolved catalyst,
wherein the dissolved catalyst includes one or more of an organometallic compound of nickel (Ni), molybdenum (Mo), cobalt (Co) or other metal naphthenates or octanoates having hydrogenation activity, and
wherein the dispersed catalyst includes one or more of an alkali metal hydroxide or oxide, Ni—Mo oxides or sulphides, Co—Mo oxides or sulphides, W—Mo oxides or sulphides on alumina or zeolites, or some combination having hydroprocessing and/or hydrogen transfer activity.

8. The method of claim 1, further comprising:
prior to introduction of the hydrocarbon stream to the pre-heater, injecting one or more of a dissolved catalyst, hydrogen, or hydrogen containing gas into the hydrocarbon stream.

9. The method of claim 1, further comprising:
introducing one or more of a hydrocarbonaceous plastic stream or a hydrocarbonaceous wax stream to a depolymerization unit;
generating, via the depolymerization unit, the alternative feedstock; and
injecting the alternative feedstock into a crude oil to define the hydrocarbon stream prior to introduction of the hydrocarbon stream to the pre-heater, wherein the amount of alternative feedstock is about 0.1% to about 5% of total weight of the hydrocarbon stream.

10. A system for upgrading crude oil to a lower boiling point hydrocarbon feed material, the system comprising:
a feeding device to transport a hydrocarbon stream that includes an alternative feedstock;
a first cracking unit that receives the hydrocarbon stream from the feeding device, the first cracking unit operable, at a first pressure, to partially crack the hydrocarbon stream via one or more of thermal cracking or catalytic cracking to produce a lower boiling point hydrocarbon feed material, a catalyst rich heavy hydrocarbon stream, and coke;
a slurry settler that receives the catalyst rich heavy hydrocarbon stream and coke from the first cracking unit, the slurry settler operable to separate the catalyst from the catalyst rich heavy hydrocarbon stream and coke thereby defining a catalyst rich stream, a heavy hydrocarbon stream, and coke, the catalyst rich stream being transported from the slurry settler for re-use or regeneration;
a coke settler that receives the heavy hydrocarbon stream and coke from the slurry settler, the coke settler operable to separate hydrocarbons from coke in the heavy hydrocarbon stream, thereby defining particulate coke and another hydrocarbon stream; and
a second cracking unit that receives the lower boiling point feed material from the first cracking unit, the second cracking unit operable to produce olefins and aromatics.

11. The system of claim 10, further comprising:
a flash drum that receives the pre-heated hydrocarbon stream, the flash drum operable to produce a volatile hydrocarbon stream with a boiling point less than or equal to 200° Celsius,
wherein the volatile hydrocarbon stream is transported to the second cracking unit,
wherein a remaining pre-heated hydrocarbon stream is transported to the first cracking unit, and
wherein the remaining pre-heated hydrocarbon stream has a boiling point greater than or equal to 200° Celsius or greater than the boiling point of the volatile hydrocarbon stream.

12. The system of claim 10, wherein the second cracking unit includes one or more of a fluid catalytic cracking unit, a steam cracker unit, or a catalytic naphtha reformer unit,
wherein the second cracking unit additionally receives the another hydrocarbon stream from the coke settler, and
wherein the first cracking unit (1) receives the another hydrocarbon stream from the coke settler and (2) is operable to further process the another hydrocarbon stream to extinction.

13. The system of claim 10, further comprising a depolymerization unit to generate the alternative feedstock from one or more of a hydrocarbonaceous plastic stream or a hydrocarbonaceous wax stream.

14. The system of claim 10, further comprising a guard bed to receive the another hydrocarbon stream prior to transport to production equipment, the guard bed operable to remove trace metals from the another hydrocarbon stream.

15. The system of claim 10, wherein the first catalytic unit utilizes
one or more of dispersed catalyst or a dissolved catalyst,
wherein the dissolved catalyst includes one or more of an organometallic compound of nickel (Ni), molybdenum (Mo), cobalt (Co) or other metal naphthenates or octanoates having hydrogenation activity,
wherein the dispersed catalyst includes one or more of an alkali metal hydroxide or oxide, Ni—Mo oxides or sulphides, Co—Mo oxides or sulphides, W—Mo oxides or sulphides on alumina or zeolites, or some combination having hydroprocessing and/or hydrogen transfer activity,
wherein the first catalytic unit includes an additive to scavenge chlorides and one or more other halides, and
wherein the additive includes one or more of oxides, carbonates, bicarbonates, hydroxides of alkali metals, alkali earth metals, or transition metals.

16. The system of claim 10, wherein the first catalytic unit utilizes an acidic catalyst to crack the hydrocarbon stream.
